(19) United States
(12) Patent Application Publication
(10) Pub. No.: US 2012/0123062 A1
(43) Pub. Date: May 17, 2012

(54) Process for preparing carbodiimides

(75) Inventors: Wilhelm Laufer, Ellerstadt (DE); Anke Blaul, Darmstadt (DE); Bernd Kray, Speyer (DE); Michael Wuehr, Hirschberg (DE)

(73) Assignee: RHEIN CHEMIE RHEINAU GMBH, Mannheim (DE)

(21) Appl. No.: 13/318,482

(22) PCT Filed: May 3, 2010
(86) PCT No.: PCT/EP2010/055977

§ 371 Date: Jan. 6, 2012

(30) Foreign Application Priority Data
May 15, 2009 (DE) 100200900210602.2

(51) Int. Cl. C08L 67/03; C08L 75/04; C08G 18/16

(52) U.S. Cl. 525/418; 528/51; 525/457

(57) ABSTRACT

A method for producing compounds comprising at least one carbodiimide group is described, by reacting at least one isocyanate-containing starting compound or a derivative thereof, wherein the method is conducted in at least two stages.

The present invention relates to a process for preparing carbodiimides. Further provided by the present invention are the carbodiimides obtainable by the process of the invention.

The present invention further relates to carbodiimides having a high molecular weight and/or low polydispersity, and also to the use of carbodiimides of the invention, among other uses, as stabilizers against the hydrolytic degradation of compounds containing ester groups, and as crosslinkers and chain extenders in plastics. At relatively high molecular weight and at comparable molecular weight combined with lower polydispersity, carbodiimides in these applications exhibit a higher stability.

Organic carbodiimides are known and find use as, for example, a stabilizer against the hydrolytic degradation of compounds containing ester groups, examples being polyaddition products and polycondensation products, such as polyurethanes. Carbodiimides can be prepared by commonly known processes, as for example by exposure of mono- or polyisocyanates to catalysts, with elimination of carbon dioxide. Suitable catalysts include, for example, heterocyclic compounds containing phosphorus, such as phospholines, phospholenes and phospholidines, and also their oxides and sulphides, and/or metal carbonyls.

Carbodiimides of these kinds, their preparation and use as stabilizers against the hydrolytic cleavage of polyester-based plastics are described in U.S. Pat. No. 5,597,942, U.S. Pat. No. 5,733,959 and U.S. Pat. No. 5,210,170, for example.

DE 10 2004 041 605 A1 describes a carbodiimide having a particular structural definition, and also processes for its preparation. In the specific examples, preparation takes place in the absence of solvent, i.e. in bulk. The carbodiimide preparation there takes place in the presence of catalysts (more particularly in the presence of methyl-2,5-dihydrophospholene 1-oxides and/or 1-methyl-2,3 dihydrophospholene 1-oxides). The catalysts can be removed subsequently from the polycarbodiimide by distillation. The polycarbodiimides obtained (which still contain isocyanate groups) are reacted thereafter with further acrylates (terminal functionalization).

U.S. Pat. No. 6,498,225 relates to block copolymers which include a carbodiimide unit among others. The carbodiimides are prepared in the presence of basic catalysts at elevated temperature with elimination of carbon dioxide. In the examples, the carbodiimides are prepared in a solvent (xylene).

EP 0 965 582 A discloses specific carbodiimides based on 1,3-bis(1-methyl-1-isocyanatoethyl)benzene, containing 12% to 40% by weight of ethylene oxide units. The carbodiimides are prepared conventionally, as already described above. The reaction here may be carried out in the absence or else in the presence of organic solvents.

EP 0 940 389 A describes structurally specific carbodiimides which as well as the carbodiimide function contain urethane groups and/or urea groups, the carbodiimide structures being attached to non-aromatic carbon atoms. Further described are a process for preparing these carbodiimides, and also mixtures which comprise these carbodiimides. The preparation of the carbodiimides here takes place in the absence or in the presence of organic solvents. In the examples, the synthesis takes place in the absence of a solvent, i.e. in bulk.

EP 1 125 956 A relates to structurally specific carbodiimides which additionally contain urea groups and/or sulphonic acid groups and/or sulphonate groups. These carbodiimides are prepared by reacting 1,3-bis(1-methyl-1-isocyanatoethyl)benzene with at least one aminosulphonic acid and/or at least one aminosulphonate in the presence of conventional catalysts, the reaction being carried out preferably in solvents. When the desired NCO group content has been reached, the formation of polycarbodiimide is interrupted and the catalysts are removed by distillation or deactivated. In the examples, a polycarbodiimide obtained according to U.S. Pat. No. 5,597,942 is used as a reactant; there is no detailed description of the carbodiimide preparation in the examples.

EP 0 792 897 A discloses specific aromatic polycarbodiimides and their conventional preparation by means of phosphorus-containing catalysts. The preparation takes place in a solvent. An isocyanate may be added at the start, in the middle or at the end of the reaction for preparing the carbodiimide, for the purpose of capping the end of the carbodiimide. At the end of the reaction, the reaction mixture is introduced into a solvent in which the carbodiimide is insoluble, with the consequence that it separates and can be removed from the monomer and the catalyst. In the examples, carbodiimide preparation takes place in tetrahydrofuran (THF).

U.S. Pat. No. 5,750,636 describes the preparation of polycarbodiimides in a solvent with conventional catalysts. The solvent is chlorinated.

EP 0 686 626 A relates to specific hydrophilic carbodiimides. With regard to the synthesis of the carbodiimides, reference is made to conventional processes. In the examples, carbodiimide formation takes place in bulk.

EP 0 628 541 A describes structurally specific carbodiimides and oligocarbodiimides having terminal isocyanate, urea and/or urethane groups. With regard to the preparation of the carbodiimides it is possible to operate in the presence or absence of solvents. Terminal isocyanates can also be blocked following preparation. In the examples, the carbodiimide-forming operation is conducted in the absence of solvent.

The prior art therefore discloses carbodiimide preparation processes which take place either in bulk or else in the presence of solvents.

The carbodiimides obtainable by these processes of condensation in solution or in bulk have the disadvantage of relatively low molecular weights.

Furthermore, the carbodiimides obtainable from the prior art have a polydispersity which is too high.

The object on which the present invention is based, therefore, is that of providing a process for preparing carbodiimides which produces carbodiimides which preferably have higher molecular weights than the carbodiimides obtainable with the conventional processes.

A further object on which the present invention is based is that of providing a process for preparing carbodiimides that produces carbodiimides which preferably have lower polydispersities than the carbodiimides obtainable with the conventional processes.

A further object on which the present invention is based is that of providing a process for preparing carbodiimides that produces carbodiimides which preferably have higher molecular weights than the carbodiimides obtainable with the conventional processes, and that produces carbodiimides which preferably have lower polydispersities than the carbodiimides obtainable with the conventional processes.

The present invention is based on the object, furthermore, of providing a process for preparing carbodiimides with which it is preferably possible to achieve low residual isocyanate contents in the carbodiimides. The residual isocyanate content in the carbodiimide is more particularly to be less than 1.5% by weight, based on the carbodiimide.

Lastly, the process of the invention is to feature a total reaction time which is comparable with that of the conventional processes for a comparable conversion of approximately 95%.

This object is achieved by the process of the invention for preparing compounds which comprise at least one carbodiimide group.

The process of the invention is characterized by the reaction of at least one isocyanate-containing starting compound or derivative thereof, the process of the invention being carried out in at least two stages.

In particular, in the process of the invention, at least one isocyanate-containing starting compound is subjected, in the presence of a catalyst, in a two-stage process

(1) in process step (1) first to a first polymerization in bulk, to give a first polymerization product; and

(2) in process step (2), the first polymerization product, originating from process step (1), is subjected to a second polymerization in solution.

Preferably no further catalyst is added in the second process stage.

In the second process stage, the addition of solvent takes place preferably without cooling beforehand.

In accordance with the invention it has been found that a combination process for preparing carbodiimides that comprises not only a polymerization in bulk (process step (1)) but also a polymerization in solution (process step (2)) achieves the objects defined above. The carbodiimides obtainable by the process of the invention—in comparison to the carbodiimides obtained either only with a process in bulk or else only with a process in solution—more particularly feature higher molecular masses and a lower polydispersity.

With the process of the invention, furthermore, it is possible to obtain carbodiimides which have a residual isocyanate content of preferably less than 2.00% by weight, more preferably less than 1.5% by weight, with particular preference less than 1.00% by weight, especially less than 0.75% by weight.

The total reaction time to be applied for the process of the invention is within the range of the conventional processes known from the prior art.

For the purposes of the present invention, a conventional process for preparing carbodiimide means a process in which an isocyanate-containing compound is reacted in the presence of a catalyst and with elimination of carbon dioxide to give a carbodiimide, and the process is carried out exclusively either in bulk or else exclusively in solution.

Described below are particular embodiments of the process of the invention, without the present invention being confined thereto:

The addition of the solvent for carrying out the polymerization in solution (i.e. process step (2)) takes place after an isocyanate conversion of generally 40% to 60%, preferably 45% to 55%, more particularly at approximately 50%. In the second process step, the process of the invention is carried out to an NCO content in the compounds which comprise at least one carbodiimide group of preferably not more than 2.00% by weight, more preferably not more than 1.5% by weight, very preferably not more than 1.00% by weight, especially not more than 0.75% by weight.

For the purposes of the present invention it is possible as isocyanate-containing compound to use any desired compound which comprises at least one isocyanate group. The isocyanate-containing compound is selected more particularly from the group consisting of cyclohexyl isocyanate, isophorone diisocyanate (IPDI), hexamethylene diisocyanate (HDI), 2-methylpentane diisocyanate (MPDI), methylenebis(2,6-diisopropylphenyl isocyanate) (MDIPI); 2,2,4-trimethylhexamethylene diisocyanate/2,4,4-trimethylhexamethylene diisocyanate (TMDI), norbornane diisocyanate (NBDI), methylenediphenyl diisocyanate (MDI), diisocyanatomethylbenzene, more particularly the 2,4- and the 2,6-isomer and technical mixtures of both isomers (TDI), tetramethylxylylene diisocyanate (TMXDI), 1,3-bis(1-methyl-1-isocyanatoethyl)benzene, 1,3,5-triisopropyl-2,4-diisocyanatobenzene (TRIDI) and/or dicyclohexylmethyl diisocyanate (H12MDI).

For the purposes of the present invention, the isocyanate-containing compound is selected more particularly from the group consisting of isophorone diisocyanate (IPDI), tetramethylxylylene diisocyanate (TMXDI), dicyclohexylmethyl diisocyanate (H12MDI) and 1,3,5-triisopropyl-2,4-diisocyanatobenzene (TRIDI).

For the purposes of the present invention, the isocyanate-containing compound is even more preferably 1,3,5-triisopropyl-2,4-diisocyanatobenzene (TRIDI).

It is furthermore possible, for the purposes of the present invention, to use a derivative of the isocyanate-containing starting compound. Such derivatives include more particularly compounds selected from the group consisting of isocyanurates, uretdiones, allophanates and/or biurets.

The condensation reaction of the at least one isocyanate-containing compound generally necessitates a catalyst.

In a first embodiment of the process of the invention, the catalyst comprises at least one phosphorus-containing catalyst. The catalyst may further be selected from the group consisting of phospholenes, phospholene oxides, phospholidines and phospholine oxides. The catalyst used for the reaction of the at least one isocyanate-containing starting compound is selected even more preferably from the group consisting of methyl-2,5-dihydrophospholene 1-oxide (CAS [930-38-1]), 1-methyl-2,3-dihydrophospholene 1-oxide (CAS [872-45-7]) and mixtures thereof (CAS [31563-86-7)].

In a second embodiment of the process of the invention, the catalyst is a base. The base is preferably selected from the group of alkali metal hydroxides, as for example KOH or NaOH; and alkoxides, examples being potassium tert-butoxide, potassium methoxide and sodium methoxide.

For the purposes of the present invention, the catalyst content in the first embodiment is preferably 0.001% to 1.00% by weight, more preferably 0.001% to 0.50% by weight, very preferably 0.001% to 0.02% by weight, based in each case on the at least one isocyanate-containing compound.

For the purposes of the present invention, the catalyst content in the second embodiment is preferably 0.01% to 2.00% by weight, more preferably 0.05% to 1.00% by weight, very preferably 0.1% to 0.50% by weight, based in each case on the at least one isocyanate-containing compound.

In process step (2) of the process of the invention, i.e. during the polymerization in solution, a solvent is used which is preferably selected from the group consisting of benzene, alkylbenzene, more particularly and preferably toluene, o-xylene, m-xylene, p-xylene, diisopropylbenzene and/or triisopropylbenzene; acetone; isobutyl methyl ketone; tetrahydrofuran; hexane; benzine; dioxane; N-methylpyrrolidone; dimethylformamide and/or dimethylacetamide.

In process step (2), in general, based in each case on the amount of monomer used in process step (1), 0.5% to 80% by weight of solvent is added, more preferably 1% to 50% by weight, more particularly 2% to 20% by weight.

Through appropriate choice of the reaction conditions, as for example of the reaction temperature, the type of catalyst and the amount of catalyst, and also the reaction time, the skilled person is able to adjust the degree of condensation in the usual way. The course of the reaction is most easily monitored through determination of the NCO content. Other parameters as well, examples being viscosity increase, colour deepening or CO₂ evolution, can be employed for controlling and/or monitoring the progress of the reaction.

With regard to the temperatures at which the formation of carbodiimide is carried out, it is preferred for process step (1) to be carried out at a temperature between 50 to 220° C., more preferably between 100 and 200° C., very preferably between 140 and 190° C.

The corresponding temperature at which the formation of carbodiimide is carried out can be achieved here by means of a temperature ramp. By the concept of a temperature ramp is meant, for the purposes of the present invention, that the temperature at which the formation of carbodiimide takes place is achieved not immediately but instead by slow heating.

The temperature ramp may amount for example to 1 to 10° C./30 minutes.

Process step (2) is carried out at a temperature preferably between 50 to 220° C., more preferably between 100 and 200° C., very preferably between 140 and 190° C.

In a further embodiment of the present invention, the reaction of the at least one isocyanate-containing compound is carried out in the presence of an inert gas atmosphere. In this context, either only the first process step, the reaction in bulk, or the second process step, the reaction in solution, may be carried out in the presence of an inert gas atmosphere.

In a preferred embodiment, however, both process steps are carried out in the presence of an inert gas. As inert gas it is preferred to use argon, nitrogen or any desired mixture of these gases.

When the reaction mixture possesses the desired NCO group content, the formation of polycarbodiimide is typically ended. This can be done, in the case where phosphorus-containing catalysts are used, by distilling off the catalysts under reduced pressure or by adding a deactivator, such as phosphorus trichloride, for example. The catalysts are preferably removed by distillation.

In a further embodiment of the present invention, accordingly, the process of the invention, after process step (2), includes a process step (3) in which

(3.1) at least one catalyst is removed distillatively from the carbodiimide compound and/or

(3.2) at least one catalyst is deactivated by addition of a deactivator, such as phosphorus trichloride, for example.

The reaction mixture, optionally, is also subjected to the following work-up procedure (process 3.3), where removal and/or deactivation of the catalyst in accordance with process steps (3.1) and/or (3.2) above may take place prior to the work-up.

For this purpose, further solvent may be added to the reaction mixture obtainable from process step (2), depending on the amount of solvent already added in process step (2). Alternatively, if sufficient solvent has already been added in process step (2), it is also possible to forego the addition of further solvent.

If, in the context of the work-up procedure, a solvent is added after process step (2), this solvent may be the same solvent also used in the solvent polymerization in process step (2) and already described above. Accordingly, reference is made to that earlier description.

The carbodiimide is subsequently precipitated by addition of a polar solvent, such as acetone, ethyl acetate, ethanol or methanol.

This work-up procedure (variant 3.3) is especially preferred.

A further work-up procedure involves subjecting the polymerization product, originating from process step (2), directly to removal of the solvent, and converting the resultant residue into the end product.

Preference is given, in accordance with the invention, to carbodiimides which have a carbodiimide formation catalyst content of less than 25 ppm in the end product, i.e. after the work-up procedure.

Additionally provided by the present invention in a first embodiment is a carbodiimide which is characterized by a molecular weight M_{w} of 20 000 to 40 000 g/mol, preferably 25 000 to 35 000 g/mol, more preferably 26 000 to 34 000 g/mol.

The molecular weight of the carbodiimides obtained in accordance with the invention is higher than the molecular weight of corresponding carbodiimides which are obtained by pure bulk polymerization or pure polymerization in solution, as illustrated by the examples described below.

Taking account of environmental and toxicological considerations, it is preferred for the carbodiimide to have a final isocyanate content of not more than 2.00% by weight, preferably not more than 1.50% by weight, more preferably not more than 1.00% by weight, especially not more than 0.75% by weight.

The physical, mechanical and rheological properties of carbodiimides are determined by the polymolecularity (the ratio of weight average to number average). This ratio is also termed polydispersity D and is a measure of the breadth of a molar mass distribution. The greater the polydispersity, the broader the molar mass distribution too. The molecular weights were determined preferably by gel permeation chromatography in tetrahydrofuran at 40° C. against polystyrene standards. For the measurements, for example, three columns connected in series (and consisting of polystyrene crosslinked with divinylbenzene) from the company PSS Polymer Standards Service GmbH were used, with a particle size of 5 μm and with pore sizes of between 100 and 500 Å, using a flow rate of 1 ml/min.

Additionally provided by the present invention, therefore, in a second embodiment, is a carbodiimide which is characterized by a polydispersity of less than 2.5, preferably less than 2.25, more preferably less than 2.00, especially between 1.6 and 1.8.

In a further embodiment of this carbodiimide in the second embodiment, the carbodiimide has a molecular weight M_{w} of 20 000 to 40 000 g/mol, preferably 25 000 to 35 000 g/mol, more particularly 26 000 to 34 000 g/mol.

Additionally provided by the present invention, in a third embodiment, is a carbodiimide which is obtainable by the process described above.

This carbodiimide, obtained by the process of the invention, has a molecular weight M_{w} of 20 000 to 40 000 g/mol, preferably 25 000 to 35 000 g/mol, more preferably 26 000 to 34 000 g/mol.

Furthermore, this carbodiimide, obtained by the process of the invention, has a polydispersity of less than 2.5, preferably less than 2.25, more preferably less than 2.00, especially between 1.6 and 1.8.

The carbodiimides obtained may also, furthermore, be terminally functionalized. Corresponding terminal functionalizations are described in DE 10 2004 041 605 A1, whose disclosure content in this respect is incorporated by reference into the present invention.

After the end of carbodiimidization, the free terminal isocyanate groups of the carbodiimides of the invention and/or of the oligomeric polycarbodiimides may therefore be blocked with C—H- or N—H-reactive hydrogen compounds, or fully or partly saturated with aliphatic, cycloaliphatic and/or araliphatic amines, similar alcohols and/or alkoxypolyoxyalkylene alcohols. According to one advantageous embodiment, for the full saturation of the isocyanate groups, the aliphatic, cycloaliphatic or araliphatic amines, alcohols and/or alkoxypolyoxyalkylene alcohols are added, preferably in a small excess of —OH, —NH and/or —NH₂ groups to NCO groups, to the reaction mixture comprising (poly)carbodiimides, are allowed to react therein, and thereafter, optionally, are subjected to distillation to remove the unreacted quantity, preferably under reduced pressure.

According to another process variant, which is preferably applied, the (poly)carbodiimides of the invention with partially or fully saturated isocyanate groups may be prepared by first reacting up to 50% by weight, preferably up to 23% by weight, of the isocyanate groups with at least one aliphatic, cycloaliphatic or araliphatic amine, alcohol and/or alkoxypolyoxyalkylene alcohol, and thereafter subjecting the free isocyanate groups, in the presence of catalysts, with elimination of carbon dioxide, wholly or partly to condensation to form carbodiimides and/or oligomeric polycarbodiimides.

The monocarbodiimides and/or oligomeric polycarbodiimides of the invention are outstandingly suitable as acceptors for carboxyl compounds and therefore find application, preferably, as stabilizers against the hydrolytic degradation of compounds containing ester groups, examples being polymers containing ester groups, e.g. polycondensation products such as, for example, thermoplastic polyesters such as polyethylene terephthalate and polybutylene terephthalate, polyetheresters, polyamides, polyesteramides, polycaprolactones and also unsaturated polyester resins and polyesteresters, such as, for example, block copolymers of polyethylene terephthalate or butylene terephthalate and polycaprolactone, and polyaddition products, examples being polyurethanes, polyureas and polyurethane-polyurea elastomers, which contain ester groups. These compounds containing ester groups are common knowledge. Their starting substances, preparation processes, structures and properties are described widely in the standard literature. On account of their ready solubility in the synthesis components for preparing polyurethanes, and of their high compatibility with the polyurethanes formed, the (poly)carbodiimides of the invention are suitable more particularly as stabilizers against the hydrolytic degradation of polyurethanes, preferably compact or cellular polyurethane elastomers, and more particularly thermoplastic polyurethanes, and also cellular or compact elastomers.

The carbodiimides of the invention are used more particularly for producing polymeric films, especially PET (polyethylene terephalate) films, TPU (thermoplastic polyurethane) films and PLA (polylactic acid) films.

The present invention, without limitation, is elucidated in more detail in the examples which follow.

### WORKING EXAMPLES

Four processes in all were carried out for the preparation of carbodiimides:

Experiment a): Bulk Polymerization

In a baked, 500 ml flask with flat-ground joints and filled with nitrogen, 306 g of triisopropylbenzyl diisocyanate are introduced under nitrogen and heated to 140° C. Following addition of 19 mg of 1-methylphospholene oxide, the reaction mixture is heated to 180° C. over the course of 5 hours. It is allowed to react at that temperature for 43 hours, and an NCO content of 2.1% (corresponding to 93% conversion) is attained.

Experiment b): Solution Polymerization

In a baked, 500 ml flask with flat-ground joints and filled with nitrogen, 420 g of a 50% strength solution of triisopropylbenzyl diisocyanate in diisopropylbenzene are introduced under nitrogen and heated to 140° C. Following addition of 0.005% of MPO (12 mg), based on the isocyanate, the reaction mixture is heated to 180° C. over the course of 5 hours. It is allowed to react at that temperature for 43 hours, and an NCO content of 3.4% (corresponding to 77% conversion) is attained.

Experiment c): Combination Process

In a baked, 500 ml flask with flat-ground joints and filled with nitrogen, 420 g of triisopropylbenzyl diisocyanate are introduced under nitrogen and heated to 140° C. Following addition of 24 mg of 1-methylphospholene oxide, the reaction mixture is heated to 180° C. over the course of 5 hours. After 3 hours at this temperature, 48 g of diisopropylbenzene are added. Subsequently, reaction is allowed to take place at 180° C. for a further 40 hours, and an NCO content of 1.1% (corresponding to 96% conversion) is attained.

Evaluation:

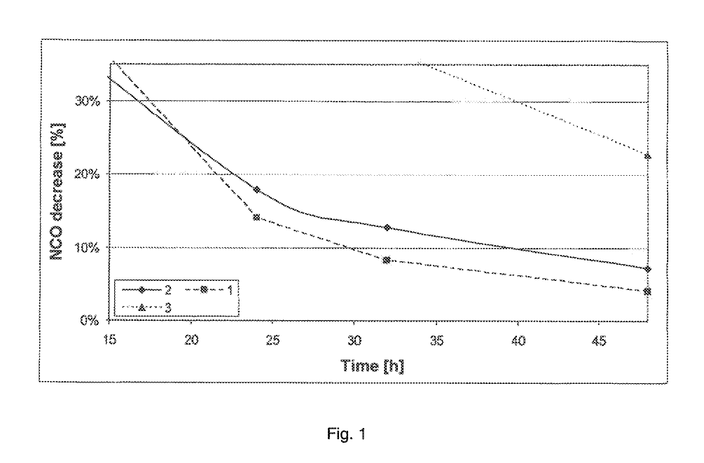

Since the isocyanate content is determined per gram of substance, the isocyanate contents shown in FIG. 1 already take account of the different quantities of solvent, for the purpose of better comparability.

The decrease in the NCO content shows that the polymerization in a 50% strength solution is the slowest reaction (comparison: solution polymerization). After 48 hours, just under 23% of the initial amount of NCO is still present.

In the other two cases, the polymerization is in bulk for the first 8 hours. The greater decrease in reaction rate becomes clear after about 15 hours; cf. FIG. 1. Accordingly, after a reaction time of 48 hours in bulk, 7.2% of the original concentration of isocyanate is still present, whereas in the combination process only 4.1% is still present.

The NCO profile over a reaction time of 15 to 48 hours is shown in FIG. 1. In the figure, the curve for (1) shows the decrease in NCO content for the combination process of the invention (square). Serving for comparison are (2) the reaction in bulk (diamond) and (3) the reaction in solution (triangle).

As a result of this it is clear that the process of the invention proceeds more quickly than the conventional processes of bulk polymerization and of pure solvent polymerization.

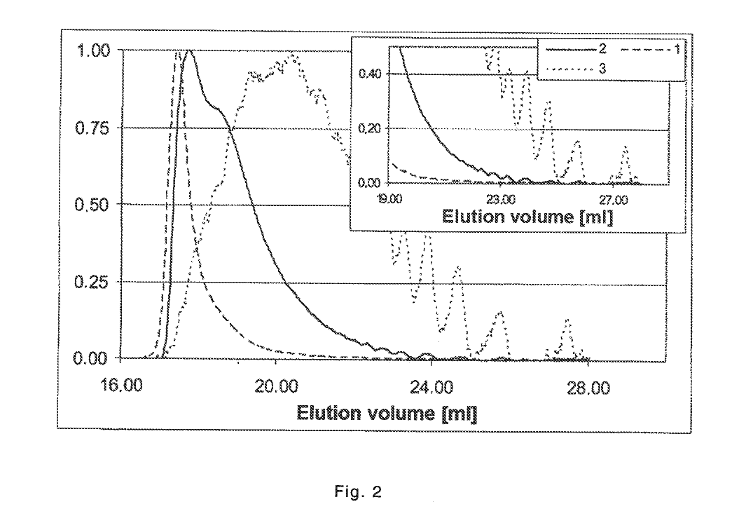

Depicted in FIG. 2 are the elution diagrams (measured in THF against polystyrene standard) of the process variants of carbodiimidizations in bulk (comparison, solid line (2)), in solution (comparison, dotted line (3)) and in the combination process of the invention (dashed line, (1)).

The solvent signal has been excised.

A comparison of the curves shows that in the combination process of the invention, the maximum lies at an elution volume of approximately 17.4 ml, whereas in the bulk process there are two peaks at higher elution volumes (17.8 ml and 18.6 ml). This observation is also reflected in the weight-average molar masses attained. Hence the weight-average molar mass in the bulk polymerization is 13 800 g/mol, whereas in solution a weight-average molar mass of only 4600 g/mol is attained. After the same time, the combination process of the invention yields a weight-average of 28 900 g/mol, which is therefore about twice as large as that in the bulk polymerization. Table 2 indicates the weight-average and number-average molar masses and also the polydispersity for the three process variants. The chromatograms already show that the molar mass distribution is the smallest by the combination process. This visual impression is confirmed by the polydispersity values, as shown in Table 2.

TABLE 1
NCO decrease/free isocyanate in the course of
the reaction for the three process variants.

| Time | Bulk | Solution | Combination |
|---|---|---|---|
| [h] | (comparison) | (comparison) | (inventive) |
| 0 | 100.00% | 100.00% | 100.00% |
| 2 | 86.70% | 92.11% | 92.18% |
| 4 | 68.78% | 84.69% | 81.29% |
| 6 | 59.52% | 79.73% | 63.27% |
| 8 | 40.53% | 71.29% | 52.38% |
| 24 | 17.93% | 44.76% | 14.02% |
| 32 | 12.82% | 37.01% | 8.23% |
| 48 | 7.21% | 22.79% | 4.12% |

For ease of comparison, the solvent fraction has not been taken into account.

TABLE 2
GPC data for the three process variants from measurements
in THF against polystyrene standards.

| | Mn | Mw | |
|---|---|---|---|
| Process | [g/mol] | [g/mol] | D |
| Bulk | 4900 | 13 800 | 2.78 |
| (comparison) | | | |
| Solvent | 1500 | 4600 | 2.99 |
| (comparison) | | | |
| Combination | 13 300 | 28 900 | 2.18 |
| (inventive) | | | |

Experiment d): Combination Process (Inventive)

In a baked, 500 ml flask with flat-ground joints and filled with nitrogen, 420 g of triisopropylbenzyl diisocyanate are introduced under nitrogen and heated to 140° C. Following addition of 26 mg of 1-methylphospholene oxide, the reaction mixture is heated to 180° C. over the course of 5 hours. After 1.5 hours at this temperature, 45 g of diisopropylbenzene are added. Subsequently, reaction is allowed to take place at 180° C. for a further 40 hours, and an NCO content of 0.8% (corresponding to 97% conversion) is attained.

In experiment d), the NCO content before addition of the solvent is 15.4%, and the NCN content developed up to that point is 8.75%.

After the 48 hours' reaction time, the NCO content is now 0.8%, while the NCN content has grown to 12.9% (solvent is still present in the sample).

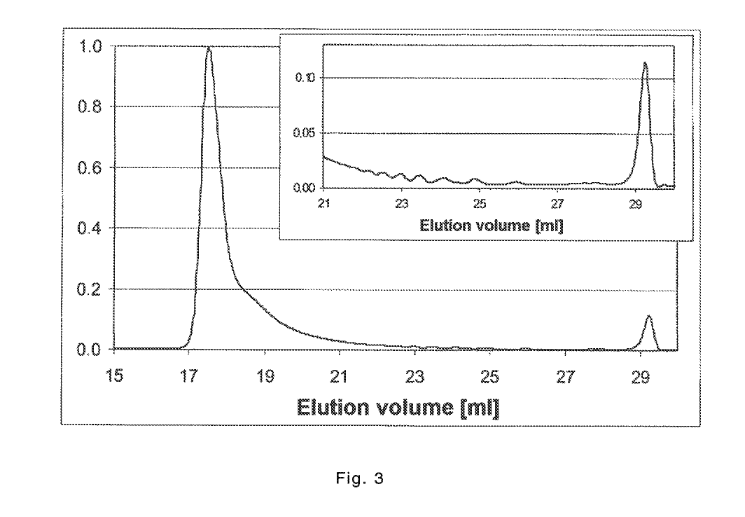

FIG. 3 shows the chromatogram of the sample after 48 hours' reaction time. The signal at approximately 29 ml originates from the solvent. The number-average and weight-average molecular weights with and without solvent signal, and also the resultant polydispersities, can be seen in Table 3.

TABLE 3
Results of GPC in THF and against polystyrene standards
for experiment d) after a reaction time of 48 hours.

| | Mn | Mw | |
|---|---|---|---|
| Evaluation: | [g/mol] | [g/mol] | D |
| with solvent | 3300 | 29 600 | 9.08 |
| without solvent | 13 500 | 30 900 | 2.29 |

Work-Up Procedure 1:

Four-hour distillation at 180° C. under reduced pressure removed a major fraction of the solvent.

Following the distillation, the NCO content is now 0.6%, while the NCN content has grown to 13.6% (residual solvent is still present in the sample).

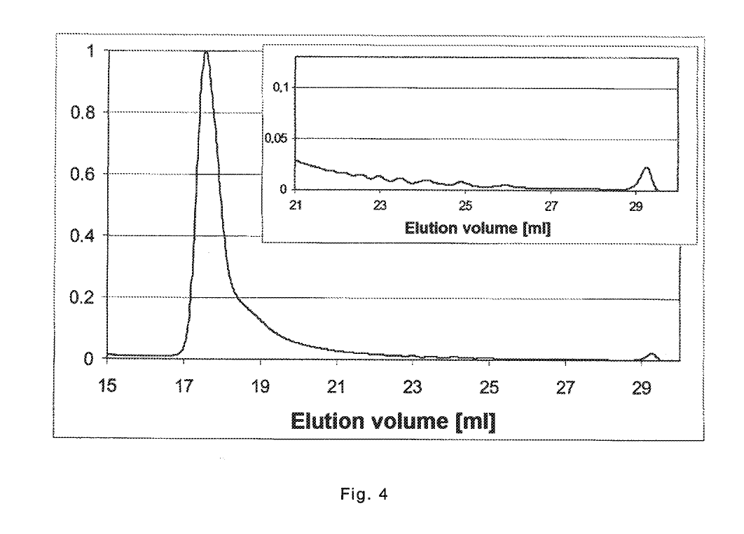

FIG. 4 shows the gel permeation chromatogram of the sample after 52 hours' reaction time (48 hours' reaction time and four hours' distillative removal of the solvent). The signal at around 29 ml originates from the solvent and has dropped markedly in comparison to the sample prior to distillation. The number-average and weight-average molecular weights with and without solvent signal, and also the resultant polydispersities, can be seen in Table 4.

TABLE 4
Results of GPC in THF and against polystyrene standards
for experiment d) after a reaction time of 48 hours and
four hours' distillative removal of the solvent.

| | Mn | Mw | |
|---|---|---|---|
| Evaluation: | [g/mol] | [g/mol] | D |
| with solvent | 8500 | 31 800 | 3.76 |
| without solvent | 15 100 | 32 100 | 2.13 |

Work-Up Procedure 2—Precipitation 1

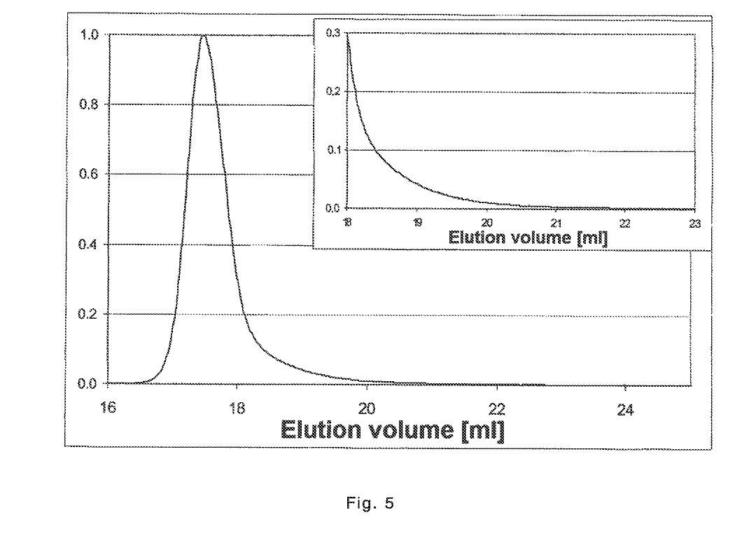

The product obtained after 48 hours reaction time is prepared as a 54% strength toluenic solution at 85° C. This solution is introduced slowly into 1.4 times the amount of acetone, and the precipitated product is filtered, washed and dried. The course of the elution volume is shown in FIG. 5.

TABLE 5
Results of GPC in THF and against polystyrene
standards for experiment d) after a reaction time
of 48 hours and precipitation from acetone.

| | Mn | Mw | |
|---|---|---|---|
| | [g/mol] | [g/mol] | D |
| Experiment d | 19 370 | 34 170 | 1.76 |
| Precipitation 1 | | | |

What is claimed is:

1. Process for preparing compounds which comprise at least one carbodiimide group by reacting at least one isocyanate-containing starting compound or a derivative thereof, characterized in that the process is carried out in at least two stages.

2. Process according to claim 1, characterized in that at least one isocyanate-containing starting compound, in the presence of a catalyst,
(1) is subjected first to a first polymerization in bulk, to give a first polymerization product; and
(2) the first polymerization product, originating from process step (1), is subjected to a second polymerization in solution.

3. Process according to claim 1 or 2, characterized in that the first polymerization in process step (1) is carried out to an isocyanate conversion of 40% to 60%.

4. Process according to any of claims 1 to 3, characterized in that the isocyanate-containing compound is selected from the group consisting of cyclohexyl isocyanate, isophorone diisocyanate (IPDI), hexamethylene diisocyanate (HDI), 2-methylpentane diisocyanate (MPDI), methylenebis(2,6-diisopropylphenyl isocyanate) (MDIPI); 2,2,4-trimethylhexamethylene diisocyanate/2,4,4-trimethylhexamethylene diisocyanate (TMDI), norbornane diisocyanate (NBDI), methylenediphenyl diisocyanate (MDI), diisocyanatomethylbenzene, and also the 2,4- and the 2,6-isomer and technical mixtures of both isomers (TDI), tetramethylxylylene diisocyanate (TMXDI), 1,3-bis(1-methyl-1-isocyanatoethyl)benzene, 1,3,5-triisopropyl-2,4-diisocyanatobenzene (TRIDI) and/or dicyclohexylmethyl diisocyanate (H12MDI).

5. Process according to any of claims 1 to 3, characterized in that the derivative of the isocyanate-containing starting compound is a derivative selected from the group consisting of isocyanurates, uretdiones, allophanates and/or biurets.

6. Process according to any of claims 2 to 5, characterized in that process step (1) is carried out at a temperature between 50 to 220° C.

7. Process according to claim 6, characterized in that the temperature defined in claim 6 is achieved by means of a temperature ramp.

8. Process according to any of claims 2 to 7, characterized in that process step (2) is carried out at a temperature between 50 to 220° C.

9. Process according to any of claims 2 to 8, characterized in that the solvent used in process step (2) is selected from the group consisting of benzene, alkylbenzene, more particularly toluene, o-xylene, m-xylene, p-xylene, diisopropylbenzene and/or triisopropylbenzene; acetone; isobutyl methyl ketone; tetrahydrofuran; hexane; benzine; dioxane; N-methylpyrrolidone; dimethylformamide and/or dimethylacetamide.

10. Carbodiimide characterized by a molecular weight M_{w} of 20 000 to 40 000 g/mol.

11. Carbodiimide characterized by a polydispersity of less than 2.50.

12. Carbodiimide according to claim 11, characterized in that the molecular weight of the carbodiimide is from 20 000 to 40 000 g/mol.

13. Carbodiimide obtainable by a process according to any of claims 1 to 9.

14. Use of a carbodiimide according to any of claims 10 to 13 as an acceptor for carboxyl compounds, as a stabilizer against the hydrolytic degradation of compounds containing ester groups.

15. Use of a carbodiimide according to any of claims 10 to 13 for producing polymeric films, more particularly PET films, TPU films and PLA films.
